(19) United States
(12) Patent Application Publication
(10) Pub. No.: US 2026/0292419 A1
(43) Pub. Date: Sep. 24, 2026

(54) SOUND-PRODUCING TRANSDUCER FOR EAR-WORN HEARING DEVICE

(71) Applicant: KNOWLES ELECTRONICS, LLC, ITASCA, IL (US)

(72) Inventors: CLIFFORD RYAN GROUNDS, HUNTLEY, IL (US); WEE HAW KOO, NAPERVILLE, IL (US)

(21) Appl. No.: 19/212,226

(22) Filed: May 19, 2025

Related U.S. Application Data
(60) Provisional application No. 63/649,757, filed on May 20, 2024.

(51) Int. Cl. H04R 25/00; H04R 25/02

(52) U.S. Cl. CPC H04R 25/609; H04R 25/02; H04R 25/65; H04R 2201/003; H04R 2225/021; H04R 2225/023

(57) ABSTRACT

An ear-worn hearing device is disclosed. The device includes a receiver having a transducer housing with a stepped end-portion. One or more diaphragms disposed in the transducer housing and separate an interior of the transducer housing into a back volume and a front volume connected to a sound port at the stepped end-portion. The stepped end-portion can accommodate the diaphragm on the interior of the transducer housing and a hearing device component on an exterior of the transducer housing. A motor disposed in the transducer housing is coupled to the diaphragm and electrically connected to an internal or external electrical interface of the hearing device.

### FIELD OF THE DISCLOSURE

The present disclosure relates generally to hearing devices and more particularly to sound-producing transducers and assemblies suitably sized for use in ear-worn hearing devices, hearing device subassemblies, and combinations thereof.

### BACKGROUND

Ear-worn hearing devices generally comprise one or more sound-producing transducers integrated in a housing that fits on or at least partially in a user's ear. Such transducers include dynamic speakers, balanced armature receivers and combinations thereof. Hearing devices can also include a wireless transceiver, audio processor, battery, one or more microphones and various sensors. However, the integration of these and other parts in ear-worn hearing devices requires tradeoffs due to space limitations, particularly in hearing devices worn on the concha or at least partially in the ear. Thus, there is an ongoing need for improvements in transducers suitable for ear-worn hearing devices, transducer sub-assemblies and combinations thereof.

### BRIEF DESCRIPTION OF THE DRAWINGS

The objects, features and advantages of the present disclosure will become more fully apparent upon consideration of the following detailed description and appended claims in conjunction with the accompanying drawings. The drawings depict only representative embodiments and implementations and are not considered to limit the disclosure, the scope of which is set forth by the appended claims.

FIG. 1 is a representative ear-worn hearing device.

FIG. 2 is a sectional view of a representative transducer assembly comprising a single-driver sound-producing transducer and an electrical component.

FIG. 3 is a perspective view of an alternative transducer assembly configuration.

FIG. 4 is a partial sectional view of a representative ear-worn hearing device comprising a transducer assembly of the type shown in FIG. 2.

FIG. 5 is a sectional view of a representative multi-driver sound-producing transducer.

FIG. 6 is a partial sectional view of a representative ear-worn hearing device comprising a sound-producing transducer of the type shown in FIG. 5.

FIG. 7 is a representative transducer assembly comprising a multi-driver sound-producing transducer of the type shown in FIG. 5 and an electrical component.

FIG. 8 is a perspective view of an alternative transducer assembly comprising multi-driver sound-producing transducer and an electrical component.

FIG. 9 is a partial sectional view of a representative ear-worn hearing device comprising a transducer assembly of the type shown in FIG. 7.

FIG. 10 is another representative ear-worn hearing device.

FIG. 11 is a partial sectional view of an alternative ear-worn hearing device comprising an integrated electrical component.

Those of ordinary skill in the art will appreciate that the drawings are illustrated for simplicity and clarity and therefore may not be drawn to scale and may not include well-known features, that the order of occurrence of actions or steps may be different than the order described, that some or all of such actions or steps may be performed concurrently unless specified otherwise, and that the terms and expressions used herein have meaning understood by those of ordinary skill in the art except where a different meaning is specifically attributed to them.

### DETAILED DESCRIPTION

The disclosure relates to ear-worn hearing devices, sound-producing transducers and transducer assemblies sized for integration in ear-worn hearing devices, hearing device components and subassemblies, and combinations thereof. Such ear-worn hearing devices include, but are not limited to, receiver-in-canal (RIC) devices, in-the-ear (ITE) devices, in-the-canal (ITC) devices, and true wireless stereo (TWS) devices, among other earphones and body-worn hearing devices. The sound-producing transducers and assemblies described herein can be integrated with any hearing device worn on, in or over the ear, among other host devices. Representative examples are described herein.

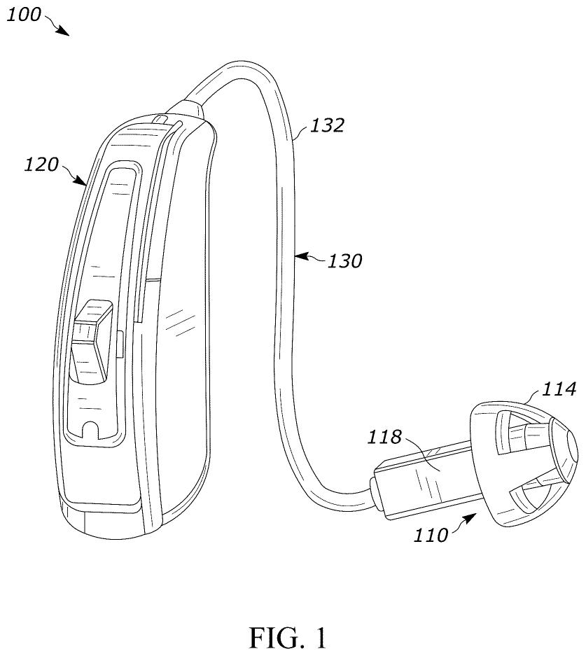

FIG. 1 is a representative ear-worn hearing device 100 generally comprising an ear-worn unit 110 connected to a base unit 120 by an electrical cable assembly 130 extending from the ear-worn unit. The cable assembly can comprise an electrical connector portion releasably or permanently connected to a mating electrical connector portion integrated with the base unit. The ear-worn unit generally comprises a speaker or receiver that generates an acoustic signal in response to an electrical audio signal provided by the base unit. The representative ear-worn unit 110 comprises a receiver 118 having a sound port through a nozzle coupled to a resilient ear dome 114 configured to support the ear-worn unit at least partially in a user's ear canal. Such an ear-worn unit alone or in combination with the electrical cable assembly can is also referred to herein as a receiver-in-canal (RIC) unit or component. Representative receivers, also referred to herein as sound-producing transducers, are described further herein. The ear-worn unit can also comprise other electrical or mechanical hearing device parts.

The representative base unit is configured for wear on a back side of the user's ear and is also referred to herein as a behind-the-ear (BTE) unit or component. A representative base unit generally comprises one or more microphones, a processor and other circuits, and a battery. Thus configured, the base unit can process acoustic audio signals (e.g., suppress noise, amplify sound, etc.) detected by the one or more microphones and provide electrical audio signals to the speaker unit via the electrical cable assembly. The base unit can also comprise other electrical or mechanical hearing device parts including but not limited to a wireless transceiver, among other circuits and electrical components. More generally, the base unit can be configured for wear on or around some other body portion, e.g., the neck, arm, waist, leg, among other body parts.

In other ear-worn hearing device, the components and functionality of the ear-worn unit and base unit are integrated in a single integrated device for wear on or in the ear. Such hearing devices can be implemented as ITE, ITC, and TWS devices, among other earphones and ear-worn hearing devices.

According to one aspect of the disclosure, a sound-producing transducer is implemented as a balanced armature receiver (also referred to herein as a “receiver”) sized for integration in an ear-worn hearing device. The receiver comprises generally one or more diaphragms located in a transducer housing and separating an interior of the transducer housing into at least a back volume and a front volume. The transducer housing comprises a stepped end-portion having a sound port coupled to the front volume. A motor located in the transducer housing comprises an armature connected to the diaphragm and is electrically connected to contacts of an electrical terminal accessible from an exterior of the transducer housing. The stepped end-portion can reduce the size of at least a portion of the hearing device and provide space to accommodate other components when the receiver is integrated with a hearing device.

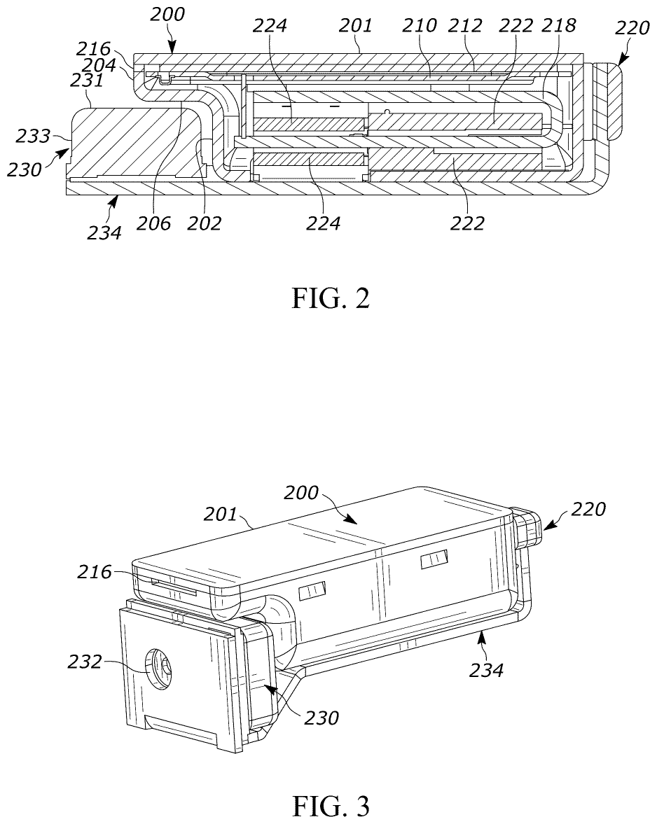

In FIGS. 2 and 5, representative receivers 200 each comprise a transducer housing 201 including a stepped end-portion and an opposite end-portion. The stepped end-portion comprises a first recessed wall portion 202 separated from a protruding wall portion 204 by a first offset wall portion 206. A diaphragm 210 located in the transducer housing separates an interior of the transducer housing into a front volume 212 and a back volume 214. In some implementations, the diaphragm extends into the stepped end-portion of the transducer housing to provide substantially the same sound output as a same-sized transducer without the stepped end-portion. A sound port 216 disposed through the stepped end-portion extends between the front volume and an exterior of the transducer housing. Alternatively, the sound port can be disposed through another wall portion of the transducer housing. A motor located in the transducer housing comprises an armature 218 connected to the diaphragm by a drive rod or other link. An electrical terminal 220 comprising contacts accessible from the exterior of the transducer housing is electrically connected to a coil 222 disposed about the armature. Coil wires can be electrically connected to interior-contacts on an interior side of the electrical terminal and the interior-contacts can be electrically connected to contacts on an exterior side of the electrical terminal by vias or other conductors extending through the electrical terminal. An electrical signal applied to the coil via the electrical terminal causes a movable portion of the armature to vibrate between permanent magnets 224 of the motor. The vibrating armature vibrates the diaphragm to produce acoustic energy at the sound port.

In some implementations, one or more components can be located at the stepped end-portion of the transducer housing when the receiver is integrated with a hearing or other host. The component can be an electrical or non-electrical part. Representative components include but are not limited to microelectromechanical systems (MEMS) microphones, accelerometers, MEMS vibration sensors, telecoils, physiological sensors, and environmental sensors, among other known and future sensors and hearing device components. The electrical component can be electrically connected to the electrical terminal of the transducer housing. Alternatively, the electrical component can be connected to some other electrical interface of the hearing device or host. The other electrical interface can be part of an electrical circuit or an electrical component like an analog-to-digital (D/A) converter, multiplexor, processor, etc. located within the hearing device.

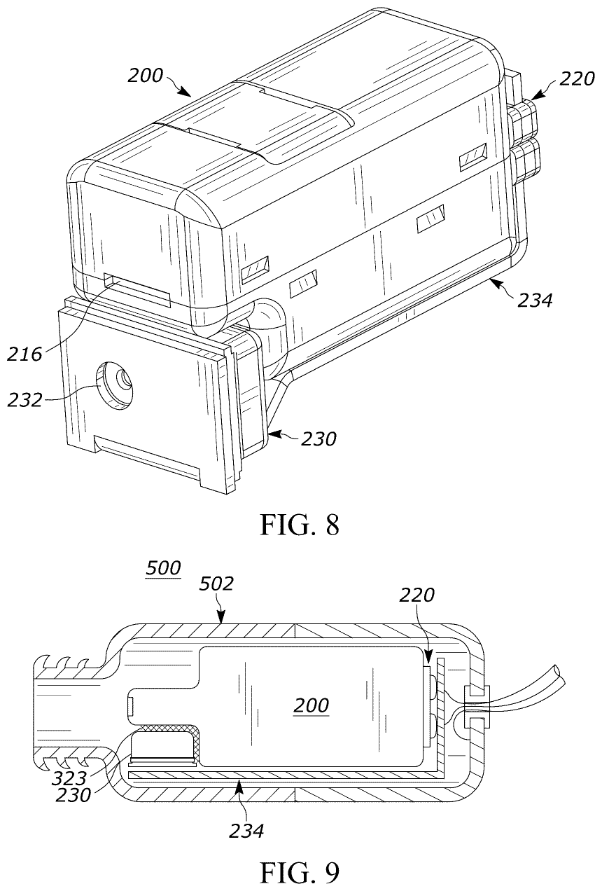

In FIGS. 2-3 and FIGS. 7-8, the sound-producing transducer 200 comprises an electrical component 230 located at a first step on an exterior of the transducer housing. The first step is defined by the first recessed wall portion 202 and the first offset wall portion 206 of the transducer housing, shown best in FIGS. 2 and 7. In FIGS. 2 and 3, the transducer 200 is a single-driver device. In FIGS. 7 and 8, the transducer 200 is a multi-driver device of the type generally described herein with reference to FIG. 5. In FIGS. 3 and 8, the electrical component is a MEMS microphone comprising a sound port 232 facing the same direction as the receiver sound port 216. Alternatively, the sound ports 216 and 232 can be oriented in different directions, provided they function as intended when integrated with the host device. In FIG. 2, for example, the microphone port can be located on a top surface 231, any side surface 233, or on a bottom surface of the microphone or other sensor that requires a port. In other implementations, the electrical component can be a different type of sensor or component, examples of which are described herein. Some components, like vibration sensors, do not require a sound port. In other electrical components, like physiological sensors, output/input ports of the component may also be oriented in other directions compared to the sensor sound port examples described. The electrical components 230 in FIGS. 2 and 7 have different orientations relative to the transducer housing 201 compared to the electrical components 230 of FIGS. 3 and 8.

In FIGS. 2-3 and 7-8, the electrical component 230 is electrically connected to the electrical terminal 220 by a circuit 234 comprising one or more conductors that electrically connect one or more connect contacts of the electrical component to corresponding contacts of the electrical terminal. Contacts of the electrical terminal can be accessible from an exterior of the transducer housing. In other implementations, the electrical component can be electrically connected to an electrical interface (not shown) other than the electrical terminal 220. The conductors can be part of a circuit comprising a rigid or flexible body. In one implementation, the circuit is a flexible ribbon circuit.

The sound-producing transducer and electrical or non-electrical component can be integrated, with or without the circuit, to form a subassembly that can be more readily integrated with a hearing device or other host. The component can be fastened to the transducer housing by an adhesive, interference fit, or mechanical retention features, among other fastening means. In one implementation, the subassembly comprises a component fastened to the stepped end-portion of the transducer housing. In subassemblies that also comprise an electrical component, one or more conductors can be electrically connected to at least the electrical component and possibly to the electrical terminal. The conductors, e.g., a flexible ribbon circuit, can also be fastened to the transducer housing by an adhesive, two-sided tape, or other fastening means. Alternatively, the sound-producing transducer, component and conductors can be discrete parts separately integrated with the host device.

In one representative hearing device implementation, the hearing device comprises a sound-producing transducer at least partially disposed in an outer housing. A transducer housing of the sound-producing transducer comprises a stepped end-portion including a recessed wall portion separated from a protruding wall portion by an offset wall portion. A diaphragm disposed in the transducer housing extends into the stepped end-portion and separates an interior of the transducer housing into a back volume and a front volume. A sound port located in the stepped end-portion extends through the transducer housing between the front volume and an exterior of the transducer housing. A motor disposed in the transducer housing comprises an armature coupled to the diaphragm. The motor can be electrically connected to a conductor of an electrical cable assembly via an electrical terminal on an interior or exterior of the sound-producing transducer as described herein in implementations where an in-ear unit is separate from a base unit.

In some implementations, the sound-producing transducer further comprises an electrical or non-electrical component located at the stepped end-portion of the transducer housing. The component is located outside the back volume of the transducer housing and can be located within an outer housing of the hearing device. The component can be electrically connected to the electrical terminal of the sound-producing transducer or to another electrical interface by one or more electrical conductors. Such electrical conductors can be part of a flexible or other electrical circuit also located in the outer housing of the hearing device.

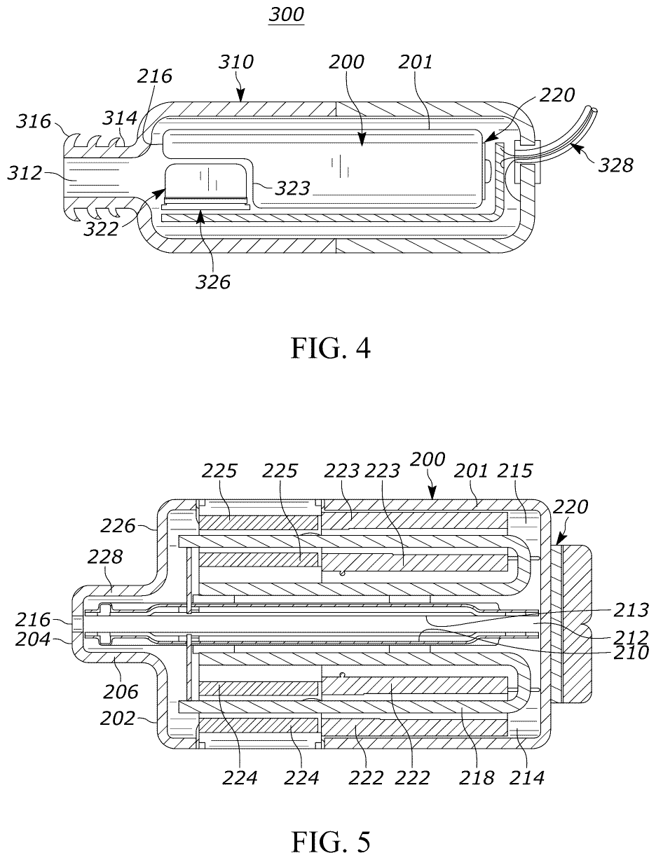

In FIG. 4, a representative hearing device 300 comprises an external housing 310 that at least partially encapsulates a portion of a sound-producing transducer 200. The external housing comprises an acoustic passage 312 through a nozzle 314 configured for at least partial insertion in a user's ear. The nozzle can include one or more ribs 316 or other features to retain an ear-dome (not shown in FIG. 4) for comfortably positioning the hearing device at least partially in the ear. A sound-producing transducer 200 comprises a transducer housing having a stepped end-portion located within the external housing 310. A sound port 216 of the sound-producing transducer is acoustically coupled to the acoustic passage 312 of the nozzle. An end portion of an electrical cable assembly 328 is electrically connected to contacts of the electrical terminal 220. A motor (not shown in FIG. 4) of the transducer 200 is also connected to contacts of the electrical terminal as described herein. Another end portion of the cable assembly can be connected to a separate base unit comprising a signal processor, microphones, batteries, a wireless transceiver, among other hearing device components as described herein.

Other hearing devices including in-the-ear (ITE), in-the-canal (ITC) and TWS hearing devices, among other earphones and hearing devices are fully self-contained and do not include an electrical cable assembly connectable to a base unit and may not require an ear dome. In such hearing devices, the transducer and electrical component can be connected to an electrical interface of a processor or controller and other electrical components within a housing of the hearing device, without the electrical cable assembly.

In FIG. 4, an electrical component 322 is also disposed in the external housing 310 at the stepped end-portion of the transducer housing 201 as described herein. The electrical component 322 is located at a first step of the transducer housing defined by the first recessed wall portion 202 and the first offset wall portion 206 described in connection with FIG. 2. In FIG. 4, an adhesive or other fastening means 323 fastens the electrical component 322 to the stepped end-portion of the transducer housing. A flex circuit 326 comprises one or more conductors electrically connected to corresponding contacts of the electrical component 322 and contacts of the electrical terminal 220. In some implementations, the flex circuit is also fastened to the transducer housing as described herein. The electrical component can be a MEMS microphone or vibration sensor, among other sensors and components, representative examples of which are described herein.

In some implementations, the sound-producing transducer is a multi-driver device comprising a second diaphragm disposed in the transducer housing between the front volume and a second back volume. Thus configured, the front volume is located between the first and second diaphragms. A second motor located in the transducer housing comprises an armature connected to the second diaphragm, and the second motor is electrically connected to contacts of the electrical terminal. In some multi-driver implementations, the stepped end-portion comprises a second recessed wall portion separated from the protruding wall portion by a second offset wall portion. The second diaphragm can also extend into the stepped end-portion of the transducer housing and the sound port can extend through the protruding wall portion. Alternatively, the sound port can extend through the offset wall portion, the recessed wall portion, or some other wall portion of the transducer housing.

In the multi-driver receiver of FIG. 5, a second diaphragm 213 located in the transducer housing 201 separates the front volume 212 from a second back volume 215. The second diaphragm extends into the stepped end-portion of the transducer housing to provide substantially the same output as a same-sized multi-driver transducer without the stepped end-portion. The front volume 212 is located between the first and second diaphragms, and the sound port 216 extends through the protruding wall portion 204. A second motor located in the transducer housing comprises an armature 219 connected to the second diaphragm 213 by a drive rod or other link. A coil 223 disposed about the armature of the second motor is electrically connected to contacts of the electrical terminal 220. The first and second motors can be connected in parallel or otherwise at the electrical terminal. An electrical signal applied to the coil 223 via the electrical terminal causes a movable portion of the armature 219 to vibrate between permanent magnets 225 of the second motor. The first and second diaphragms can be simultaneously actuated toward and away from each other to produce acoustic energy at the sound port 216.

Alternatively, the first and second diaphragms can separate the interior of the transducer housing into first and second front volumes driven by first and second motors, respectively, located in corresponding back first and second volumes. In another alternative implementation, the first and second diaphragms can be driven by a single motor in a common back volume. These and other multi-driver receivers are described in U.S. Pat. No. 11,272,294 assigned to Knowles Electronics, LLC.

In FIG. 5, the stepped end-portion comprises a second recessed wall portion 226 separated from the protruding wall portion 216 by a second offset wall portion 228. In FIG. 7, the multi-driver sound-producing transducer comprises a stepped end-portion having first and second steps, one of which accommodates an electrical component 230. In FIG. 8, a multi-driver sound-producing transducer comprises a stepped end-portion having a single step accommodating an electrical component 230.

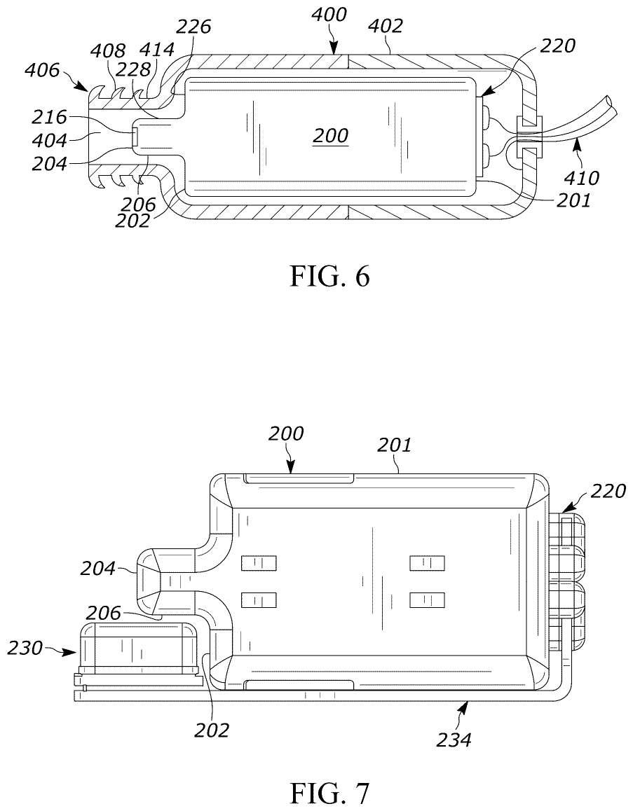

In FIG. 6, another representative ear-worn hearing device 400 comprises an external housing 402 that at least partially encapsulates a portion of a multi-driver sound-producing transducer 200 of the type generally described herein with reference to FIG. 5. The multi-driver sound-producing transducer comprises a transducer housing 201 having a stepped end-portion located within the external housing 402. The stepped end-portion comprises a first step defined by the first recessed wall portion 202 and the first offset wall portion 206. The stepped end-portion also comprises a second step defined by a second recessed wall portion 226 and a second offset wall portion 228. The sound port 216 extends through the protruding wall portion 204 between the front volume and an exterior of the transducer housing.

The external housing 402 comprises an acoustic passage 404 through a nozzle 406 configured for at least partial insertion in a user's ear. A portion 414 of the nozzle is constricted about at least a portion of the stepped end-portion of the transducer housing 201. Thus configured, the size and overall length of the hearing device can be reduced without reducing the sound output of the sound-producing transducer compared to a hearing device comprising a sound-producing transducer without a stepped end-portion. The sound port 216 is acoustically coupled to the acoustic passage 404 of the nozzle. The nozzle can include one or more ribs 408 or other features to retain an ear-dome (not shown in FIG. 6) as described herein. An electrical cable assembly 410 is connected to the outer housing 402 and comprises one or more conductors electrically connected to contacts of the electrical terminal 220 of the transducer housing for connecting to a base unit as described herein. Other hearing devices comprise components fully self-contained in a common housing and do not include an electrical cable assembly connected to a base unit and may not require an ear dome.

In FIG. 9, another representative ear-worn hearing device 500 comprises an external hearing device housing 502 that at least partially encapsulates a portion of a multi-driver sound-producing transducer 200 of the type generally described herein with reference to FIG. 7. An electrical component 230 located at a first step of the stepped end-portion of the transducer 200 is electrically connected to an electrical interface 220 of the transducer by a flex circuit 234, as described herein. In other implementations, another component may be located at a second step of the stepped end-portion of the transducer. Thus configured, the stepped end-portion of the multi-driver transducer creates space within the hearing device housing to accommodate one or more additional components without an undue increase in the overall size of the hearing device and without reducing the sound output of the sound-producing transducer.

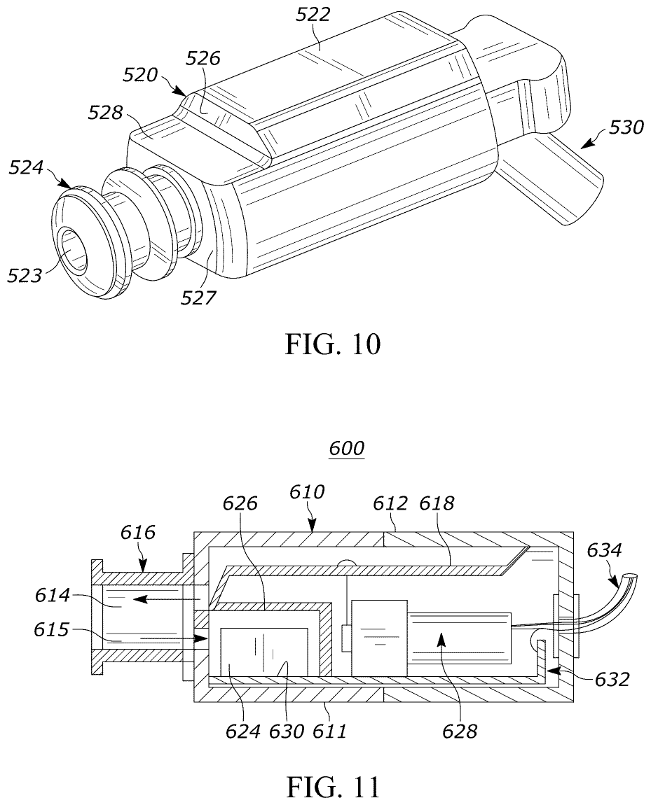

In FIG. 10, a hearing device 510 comprises a sound-producing transducer 520 comprising a transducer housing 522 having a stepped-end portion with a sound passage 523 through a nozzle 524 integrated with the transducer housing. The stepped end-portion comprises a recessed wall portion 526 separated from an end wall 527 of the transducer housing by an offset wall portion 528. The hearing device 510 is devoid of the external housing shown in FIGS. 4, 6 and 9. In FIG. 10, the transducer housing 522 constitutes an exterior of the hearing device. Thus configured, the hearing device is devoid of structure encapsulating at least the portion of the transducer housing that extends into the user's ear, reducing the overall size of the hearing device. The motor can be directly coupled to an interior surface of the transducer housing without intervening structure, further reducing the overall size of the hearing device. The stepped end-portion further reduces the size of at least the portion of the hearing device that extends into the user's ear.

In some implementations, the reduced size of the transducer housing makes space for one or more electrical or non-electrical components, e.g., a sensor, on an exterior of the transducer housing. In FIG. 10, for example, an electrical component (not shown in FIG. 10) can be fastened to a step defined by the recessed wall portion 526 and the offset wall portion 528 of the transducer housing 522. The electrical component can be electrically connected to an electrical cable assembly 530 by conductors of a flex or other circuit (not shown in FIG. 10) fastened, or not, to the transducer housing.

In FIG. 11, a hearing device 600 comprises a sound-producing transducer 610 comprising a transducer housing 612 having a sound port 614 connected to a passage through a nozzle 616 integrated with the transducer housing. The transducer housing 612 constitutes an exterior of the hearing device without an external housing shown in FIGS. 4, 6 and 9, as described with reference to the hearing device of FIG. 10. In FIG. 11, a diaphragm 618 separates an interior of the transducer housing into a back volume 620 and a front volume 622 coupled to the sound port. A motor 628 located in the back volume is connected to the diaphragm by a link as described herein. An electrical component 624 is disposed in a cavity of the transducer housing formed by an internal stepped wall partition 626 and an exterior wall portion 611. The stepped wall portion 626 isolates the electrical component 624 from the back volume 620 and can be assembled in a bottom cup of the transducer housing after installation of the electrical component. In other implementations, the transducer housing 612 is devoid of the exterior housing portion 611 encapsulating the electrical component, wherein the electrical component is located at a step on the exterior of the transducer housing.

In FIG. 11, the electrical component 624 is connected to an electrical terminal 630 located in the cavity of the transducer housing. A port 615 can connect the cavity to an exterior of the hearing device for components, like microphones, that require it. Conductors, e.g., part of a flex or other circuit, 632 located in the back volume electrically connects the electrical terminal 630 to one or more conductors of an electrical cable assembly 634. Alternatively, the electrical cable assembly 634 can be connected directly to the electrical terminal 630, without a flex circuit. In an alternative implementation, the electrical terminal constitutes a portion of the stepped wall-portion 626. The electrical component can be electrically connected to contacts on a cavity-side of the electrical terminal and conductors of the flex circuit or electrical cable assembly can be connected to contacts on an opposite side of the electrical terminal.

While the disclosure and what is presently considered to be the best mode thereof has been described in a manner establishing possession and enabling those of ordinary skill in the art to make and use the same, it will be understood and appreciated that there are many equivalents to the representative embodiments described herein and that myriad modifications and variations may be made thereto without departing from the scope and spirit of the invention, which is to be limited not by the embodiments described, but by the appended claims and their equivalents.

What is Claimed is:

1. A sound-producing transducer sized for use in an ear-worn hearing device, the sound-producing transducer comprising:
a transducer housing comprising a stepped end-portion and an opposite end-portion, the stepped end-portion comprising a first recessed wall portion separated from a protruding wall portion by a first offset wall portion;
first and second diaphragms separating an interior of the transducer housing into at least a front volume and a back volume, the first and second diaphragms extending into the stepped end-portion of the transducer housing;
a sound port located in the stepped end-portion and extending between the front volume and an exterior of the transducer housing;
a motor located in the transducer housing and connected to the first and second diaphragms; and
an electrical terminal comprising contacts accessible from the exterior of the transducer housing, the motor electrically connected to contacts of the electrical terminal.

2. The sound-producing transducer of claim 1 further comprising a sensor located at a step outside the interior of the transducer housing, the step defined by the first recessed wall portion and the first offset wall portion, and a conductor electrically connected to the sensor.

3. The sound-producing transducer of claim 2, wherein the conductor comprises a flex circuit fastened to the transducer housing.

4. The sound-producing transducer of claim 1, the stepped end-portion comprising a second recessed wall portion separated from the protruding wall portion by a second offset wall portion, the first recessed wall portion and the first offset wall portion defining a first step on a first side of the transducer housing, and the second recessed wall portion and the second offset wall portion defining a second step on a second side, opposite the first side, of the transducer housing.

5. The sound-producing transducer of claim 4 further comprising an electrical component located at the stepped end-portion outside the transducer housing, and a conductor electrically connected to the electrical component.

6. The sound-producing transducer of claim 5, wherein the conductor is a flex circuit fastened to the transducer housing.

7. The sound-producing transducer of claim 1, wherein the first diaphragm separates the front volume from a first back volume, the second diaphragm separates the front volume from a second back volume, and the sound port is located at the protruding wall portion of the stepped end-portion.

8. The sound-producing transducer of claim 7, wherein the sensor is a microelectromechanical systems (MEMS) microphone.

9. The sound-producing transducer of claim 7, wherein the sensor is a microelectromechanical systems (MEMS) vibration sensor.

10. A receiver-in-canal (RIC) hearing device comprising:
a sound-producing transducer comprising:
a transducer housing comprising a stepped end-portion including a first recessed wall portion separated from a protruding wall portion by a first offset wall portion;
a first diaphragm disposed in the transducer housing and separating an interior of the transducer housing into a first back volume and a front volume, the diaphragm extending into the stepped end-portion of the transducer housing;
a sound port located in the stepped end-portion and extending through the transducer housing between the front volume and an exterior of the transducer housing;
a motor disposed in the transducer housing and comprising an armature coupled to the diaphragm;
an electrical terminal electrically connected to the motor;
an electrical cable assembly comprising a first portion coupled to the sound-producing transducer and a second portion connectable to a base unit, the electrical cable assembly comprising an electrical conductor electrically connected to the motor via the electrical terminal;
an electrical component located at a first step of the transducer housing and isolated from the back volume, the first step defined by the first recessed wall portion and the first offset wall portion; and
a conductor electrically connecting the electrical component to the electrical terminal or another electrical interface of the RIC hearing device.

11. The RIC hearing device of claim 10, wherein the transducer housing constitutes an external housing of the RIC hearing device and the stepped end-portion is configured for at least partial insertion in an ear.

12. The RIC hearing device of claim 10 further comprising an external housing comprising an acoustic passage through a nozzle configured for at least partial insertion in an ear, the external housing covering the stepped end-portion of the transducer housing, wherein the sound port is acoustically coupled to the acoustic passage.

13. The RIC hearing device of claim 10, wherein the sound-producing transducer further comprises a second diaphragm disposed in the transducer housing and separating the front volume from a second back volume, and a second motor connected to the second diaphragm.

14. The RIC hearing device of claim 13, wherein the electrical component is a microelectromechanical systems (MEMS) microphone and the conductor constitutes a flexible circuit.

15. The RIC hearing device of claim 13, wherein the electrical component is a MEMS vibration sensor and the conductor constitutes a flexible circuit.

16. An ear-worn hearing device comprising:
a housing having a sound passage on a portion of the housing configured for at least partial insertion in an ear;
a sound-producing transducer located in the housing and comprising:
a transducer housing comprising a stepped end-portion and including a first step defined by a first recessed wall portion separated from a protruding wall portion by a first offset wall portion, and a second step defined by a second recessed wall portion separated from the protruding wall portion by a second offset wall portion, the first and second steps located on opposite sides of the transducer housing;
a first diaphragm disposed in the transducer housing and separating an interior of the transducer housing into a back volume and a front volume, the first diaphragm extending into the stepped end-portion of the transducer housing;
a sound port located in the stepped end-portion of the transducer housing between the front volume and the sound passage;
a motor disposed in the transducer housing and comprising an armature coupled to the first diaphragm; and
an electrical terminal electrically connected to the motor.

17. The ear-worn hearing device of claim 16 further comprising an electrical component located at the first step on an exterior of the transducer housing.

18. The ear-worn hearing device of claim 17 further comprising a flex circuit comprising a conductor connecting the electrical component to the electrical terminal or another electrical interface of the ear-worn hearing device.

19. The ear-worn hearing device of claim 16, further comprising:
a second diaphragm disposed in the transducer housing between the front volume and a second back volume; and
the motor connected to the second diaphragm.

20. The sound-producing transducer of claim 19, wherein the first diaphragm separates the front volume from a first back volume, the second diaphragm separates the front volume from a second back volume, and the sound port is located at the protruding wall portion of the stepped end-portion.

21. The ear-worn hearing device of claim 20, wherein the nozzle is constricted about at least a portion of the stepped end-portion of the transducer housing.

22. The ear-worn hearing device of claim 16, wherein the electrical component is a microelectromechanical systems (MEMS) microphone or MEMS vibrations sensor.

23. An ear-worn hearing device comprising:
a housing having a sound passage on a portion of the housing configured for at least partial insertion in an ear;
a sound-producing transducer at least partially disposed in the housing and comprising:
a transducer housing comprising a stepped end-portion including a first recessed wall portion separated from a protruding wall portion by a first offset wall portion;
first and second diaphragms separating an interior of the transducer housing into at least a front volume and a back volume, the first and second diaphragms extending into the stepped end-portion of the transducer housing;
a sound port located in the transducer housing and extending between the front volume and the sound passage;
a motor located in the transducer housing and connected to the first and second diaphragms;
an electrical terminal electrically connected to the motor; and
an electrical component located at a first step on an exterior of the transducer housing, the first step defined by the first recessed wall portion and the first offset wall portion.

24. The ear-worn hearing device of claim 23 further comprising a conductor connecting the electrical component to the electrical terminal or an electrical interface of the ear-worn hearing device.

25. The ear-worn hearing device of any of claim 23, wherein the first diaphragm separates the front volume from a first back volume and the second diaphragm separates the front volume from a second back volume, and the sound port is located at the protruding wall portion of the stepped end-portion.

26. The ear-worn hearing device of claim 25, wherein the electrical component is a microelectromechanical systems (MEMS) microphone or MEMS vibrations sensor.
